(19) United States
(12) Patent Application Publication
(10) Pub. No.: US 2013/0154378 A1
(43) Pub. Date: Jun. 20, 2013

(54) METHOD FOR CONTROLLING A PARALLEL LINE-INTERACTIVE UNINTERRUPTIBLE POWER SUPPLY SYSTEM

(71) Applicants: Kai-Tsung YANG, Taipei (TW); Jui-Hung Chou, Taipei (TW); Shih-Chien Tang, Taipei (TW)

(72) Inventors: Kai-Tsung YANG, Taipei (TW); Jui-Hung Chou, Taipei (TW); Shih-Chien Tang, Taipei (TW)

(21) Appl. No.: 13/326,596

(22) Filed: Dec. 15, 2011

(51) Int. Cl. H02J 9/00

(52) U.S. Cl. 307/66

(57) ABSTRACT

A method for controlling a parallel line-interactive uninterruptible power supply (UPS) system having multiple line-interactive UPSs parallelly connected, in which each line-interactive UPS has a switching element and a power output terminal connected to a load through the switching element, has a step of acquiring a switching status from the switching element when the switching element is switched to determine next switching time of the switching element so that the switching time is adjacent to a zero phase angle point of an input voltage cycle of the mains power. The method further has the switching elements of all line-interactive UPSs switched at the same time for all the line-interactive UPSs to evenly share the load, thereby preventing the line-interactive UPSs from being damaged due to concentrated load current on single line-interactive UPS arising from dramatically different switching time of the switching elements.

### BACKGROUND OF THE INVENTION

1. Field of the Invention

The present invention relates to a method for controlling an uninterruptible power supply (UPS) system and more particularly to a method for controlling a parallel line-interactive UPS system.

2. Description of the Related Art

UPS normally serves as a backup power supply supplying power to power-consuming equipment when the mains power is abnormal, such as power outage, overvoltage/undervoltage, occurrence of surge current and the like, so as to continuously supply an operating power to the load and prevent some mission-critical equipment, such as computers, telecommunication networks, private branch exchanges (PBX) and the like, from losing data or getting out of control.

Conventional UPSs can be generally classified as on-line UPSs, off-line UPSs and line-interactive UPSs.

The On-line UPSs serve to separate the AC mains and a load so that the mains power is sent to the UPSs and is converted into DC power to charge a battery set instead of being directly supplied to the load. Meanwhile, the DC power is further converted into AC power, and then the AC power is supplied to the load. Once power outage or power abnormality occurs, a battery mode is enabled and AC power is converted from the DC power of the battery set and is supplied to the load. Basically, the power waveforms outputted by the on-line UPSs and by the AC mains both pertain to sinusoidal waves.

The off-line UPSs usually play a power backup role. When the AC mains is normal, the mains power is directly supplied to the load for simultaneously charging a battery set. Once the AC mains fails, a mains power supply loop of the off-line UPSs is automatically disconnected from the AC mains and a battery mode is enabled so that the AC power converted from the DC power of the battery set is further supplied to the load.

The line-interactive UPSs are equipped with a voltage fluctuation circuit, are operated the same way as the off-line UPSs, and do not intervene to supply power when the AC mains normally supplies power. Instead, the line-interactive UPSs monitor the condition of the mains power on a real-time basis, and instantly perform voltage fluctuation or enter a battery mode to replace the AC mains and continuously supply power to the load when the AC mains supply is abnormal.

Among the forgoing types of UPSs, the on-line UPSs almost spend no time in switching power supply mode, are highly reliable and applicable to precision equipment, but are disadvantageous in having a lower power efficiency during a normal AC mains power mode approximately in a range of 88%˜90% because their power converters are continuously operated in an AC-DC-AC conversion process, which results in an inferior power conversion efficiency and more power loss. In contrast, the line-interactive UPSs do not intervene to supply power throughout the entire course of power supply when operated at a normal AC mains power mode, thereby giving rise to no additional power loss from power conversion The power efficiency of the line-interactive UPSs can be raised to 95%, which is far superior to the power efficiency, 90%, of the conventional on-line UPSs.

To achieve redundancy, multiple line-interactive UPSs can be parallelly connected by connecting an output terminal of each line-interactive UPS to a load through a switching element. When each switching element is switched on, the line-interactive UPSs are parallelly connected. Such parallel connection is implemented by simultaneously turning on the switching elements. However, if the switching times of the switching elements in fulfilling the parallel connection vary significantly, the life spans of the switching elements may be shortened.

With reference to FIGS. 5A to 5D, a relationship between the switching time of each switching element and the resulting instantaneous current is disclosed. The four curves (C1, C2, C3, C4) respectively represent the output voltage of one of the line-interactive UPSs, the gate current of each switching element of the line-interactive UPS, the instantaneous output current of the line-interactive UPS and the input voltage from the AC mains. When the switching elements are switched on at ±10° of the input voltage cycle of the AC mains, the peak value of the instantaneous output current can reach up to 50 A. With reference to FIGS. 6A to 6D, when the switching elements are switched on in the proximity of a peak of an input voltage cycle of the AC mains, the peak value of the instantaneous output current can reach up to 200 A. The foregoing large instantaneous current arising from inappropriate switching time of the switching element passes through the switching element to have a direct impact on the switching element and shorten the life span thereof.

On the other hand, since the parallel line-interactive UPS system is operated under the parallel connection framework, the switching elements of all the line-interactive UPSs must be switched on or off synchronously so that the switching element of the line-interactive UPS switched on or off first is not subjected to the entire load current to prevent the line-interactive UPS from being damaged accordingly.

### SUMMARY OF THE INVENTION

An objective of the present invention is to provide a method for controlling a parallel line-interactive UPS system enabling the switching elements of all the line-interactive UPSs to be synchronously switched on or off to ensure that all switching elements are switched on or off in the proximity of a zero phase angle point of an input voltage cycle and a load current can be evenly shared in a short period of time to prevent the switching elements and the line-interactive UPSs from being damaged.

To achieve the foregoing objective, the method for controlling a parallel line-interactive uninterruptible power supply (UPS) system having multiple line-interactive UPSs parallelly connected, wherein each line-interactive UPS has a switching element, a power output terminal connected to a load through the switching element, and a controller controlling the switching element to switch and acquiring a switching status from the switching element, is executed by the controller, and the method has steps of:

instructing the switching element to switch;

acquiring the switching status from the switching element to determine a switching time of the switching element associated with the switching status;

determining if the switching element is switched again;

if the switching element is switched again, adjusting the switching time of the switching element associated with the switching status to be located within a preset range of an input voltage cycle;

communicating with the controllers of other line-interactive UPSs to synchronously operate all the switching elements.

Preferably, in the step of adjusting the switching time of the switching element, the switching time of the switching element is adjusted in the proximity of a zero phase angle point of the input voltage cycle.

The method acquires switching statuses from each switching element when the switching element is switched on or off to ensure that a next switching time of the switching element can be positioned in the proximity of a zero phase angle point of an input voltage cycle. When the switching elements are switched on or off next time, the switching elements of all line-interactive UPSs can be switched on or off at the same time through communication among the controllers thereof to prevent the switching element from being damaged because of concentrated load current on single line-interactive UPS.

Other objectives, advantages and novel features of the invention will become more apparent from the following detailed description when taken in conjunction with the accompanying drawings.

### BRIEF DESCRIPTION OF THE DRAWINGS

FIG. 1 is a functional block diagram of a parallel line-interactive UPS system in accordance with the present invention;

FIG. 2 is a circuit diagram of a line-interactive UPS of the parallel line-interactive UPS system in FIG. 1;

FIG. 3 is a block diagram of a method for controlling the parallel line-interactive UPS system in FIG. 1;

FIG. 4A is a characteristic curve diagram for output voltage of the parallel line-interactive UPS system in FIG. 1 after switching elements thereof are switched on in the proximity of a zero phase angle point of an input voltage cycle thereof;

FIG. 4B is a characteristic curve diagram for gate current of switching elements of the parallel line-interactive UPS system in FIG. 1 after the switching elements are switched on in the proximity of a zero phase angle point of an input voltage cycle thereof;

FIG. 4C is a characteristic curve diagram for instantaneous output current of the parallel line-interactive UPS system in FIG. 1 after switching elements thereof are switched on in the proximity of a zero phase angle point of an input voltage cycle thereof;

FIG. 4D is a characteristic curve diagram for input voltage of the parallel line-interactive UPS system in FIG. 1 after switching elements thereof are switched on in the proximity of a zero phase angle point of an input voltage cycle thereof;

FIG. 5A is a characteristic curve diagram for output voltage of a conventional parallel line-interactive UPS system after switching elements thereof are switched on at ±10° of an input voltage cycle thereof;

FIG. 5B is a characteristic curve diagram for gate current of switching elements of a conventional parallel line-interactive UPS system after the switching elements are switched on at ±10° of an input voltage cycle thereof;

FIG. 5C is a characteristic curve diagram for instantaneous output current of a conventional parallel line-interactive UPS system after switching elements thereof are switched on at ±10° of an input voltage cycle thereof;

FIG. 5D is a characteristic curve diagram for input voltage of a conventional parallel line-interactive UPS system after switching elements thereof are switched on at ±10° of an input voltage cycle thereof;

FIG. 6A is a characteristic curve diagram for output voltage of a conventional parallel line-interactive UPS system after switching elements thereof are switched on in the proximity of a peak of an input voltage cycle thereof;

FIG. 6B is a characteristic curve diagram for gate current of switching elements of a conventional parallel line-interactive UPS system after the switching elements are switched on in the proximity of a peak of an input voltage cycle thereof;

FIG. 6C is a characteristic curve diagram for instantaneous output current of a conventional parallel line-interactive UPS system after switching elements thereof are switched on in the proximity of a peak of an input voltage cycle thereof; and

FIG. 6D is a characteristic curve diagram for input voltage of a conventional parallel line-interactive UPS system after switching elements thereof are switched on in the proximity of a peak of an input voltage cycle thereof.

### DETAILED DESCRIPTION OF THE INVENTION

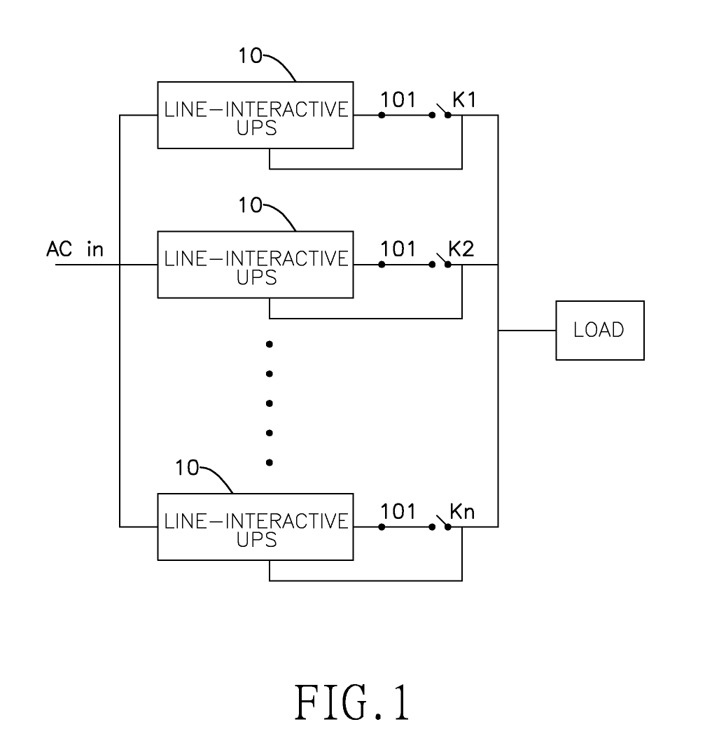

With reference to FIG. 1, a parallel line-interactive UPS system in accordance with the present invention has multiple line-interactive UPSs 10 and multiple switching elements K1˜Kn. Each line-interactive UPS 10 is connected to a load through one of the switching elements K1˜Kn.

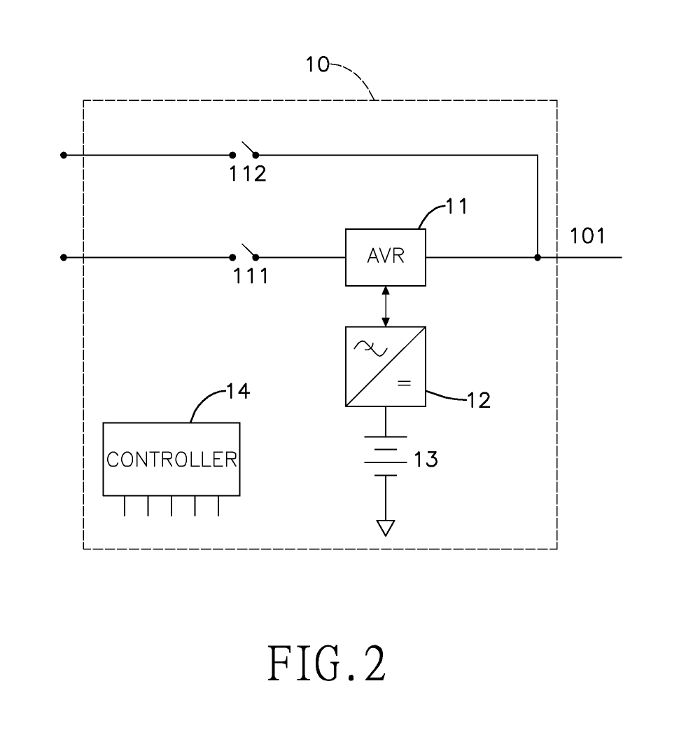

With reference to FIG. 2, each line-interactive UPS has an automatic voltage regulator (AVR) 11, an inverter 12, a battery set 13 and a controller 14.

The AVR 11 has a coil and an input terminal and an output terminal. The input terminal is connected to the AC main through a first status switch 111. The output terminal is connected to a power output terminal 101 of the line-interactive UPS. The power output terminal 101 is connected to the AC mains through a second status switch 112.

The inverter 12 is bidirectionally connected to the coil of the AVR 11. The battery set 13 is bidirectionally connected to the inverter 12. The controller 14 is connected to the inverter to control the inverter 12 to operate. The controller 14 is connected to the first status switch 111 and the second status switch 112 to control them to switch on or off. The controller 14 is further connected to the controllers 14 of other line-interactive UPSs 10 to communicate therewith.

During a normal mains power mode, the first status switch 111 is switched off and the second status switch 112 is switched on. As a result, the AVR 11 and the inverter 12 are in a non-operating state, and the AC mains inputs power to the power output terminal 101 through the second status switch. When the battery set 13 needs to be charged, the first status switch 111 is switched on, and power inputted by the AC mains is transmitted to the AVR 11. As the AVR 11 is not operated, power is transmitted to the inverter 12 through the coil of the AVR 11. At the moment, the inverter 12 serves as a charger. It is the coil of the AVR 11 that receives power and charges the battery set 13. When the battery set 13 is fully charged, the first status switch 111 is switched off, and the AC mains keeps supplying power to the power output terminal 101 through the second status switch 112.

During an abnormal mains power mode, the first status switch 111 is switched on and the second status switch 112 is switched off. The AC mains supplies power to the AVR 11 through the first status switch 111. After processing voltage fluctuation (voltage boost or voltage buck), the AVR 11 supplies power to the power output terminal 101 and charges the battery set 13 through the inverter 12.

During a mains power outage mode, the first status switch 111 and the second status switch 112 are both switched off, and after being converted into AC power by the inverter 12, DC power outputted from the battery set 13 is transmitted to the coil of the AVR 11. The AVR 11 further transmits power to the power output terminal to continuously supply power.

With further reference to FIG. 1, the power output terminal 101 of each line-interactive UPS 10 is connected to a corresponding switching element K1˜Kn so that the line-interactive UPS 10 is connected to the load through the switching element K1˜Kn. Each switching element K1˜Kn is connected to the controller 14 of a corresponding AVR 10 in a feedback fashion for the controller 14 to record actual switching timing of the switching element K1˜Kn.

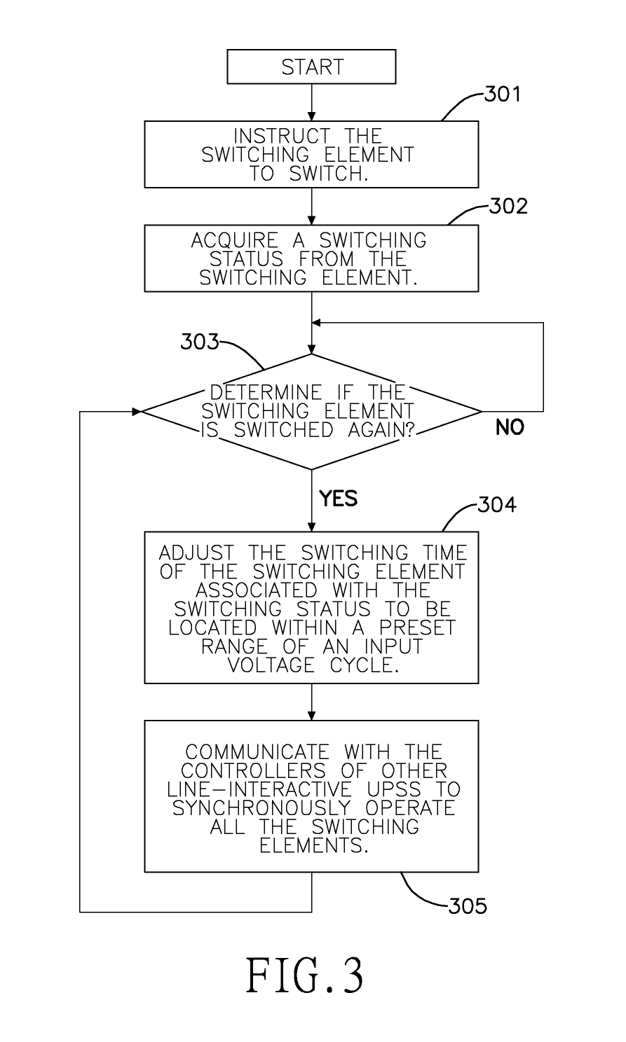

With reference to FIG. 3, under the framework of the foregoing parallel line-interactive UPS system, a method for controlling the parallel line-interactive UPS system is executed by the controllers 14 of one of the line-interactive UPSs and has the following steps.

Step 301: Instruct the switching element to switch.

Step 302: Acquire a switching status from the switching element and record a switching time of the switching element associated with the switching status.

Step 303: Determine if the switching element is switched again.

Step 304: If the switching element is switched again, adjust the switching time of the switching element associated with the switching status to be located within a preset range of an input voltage cycle.

Step 305: Communicate with the controllers of other line-interactive UPSs to synchronously operate all the switching elements.

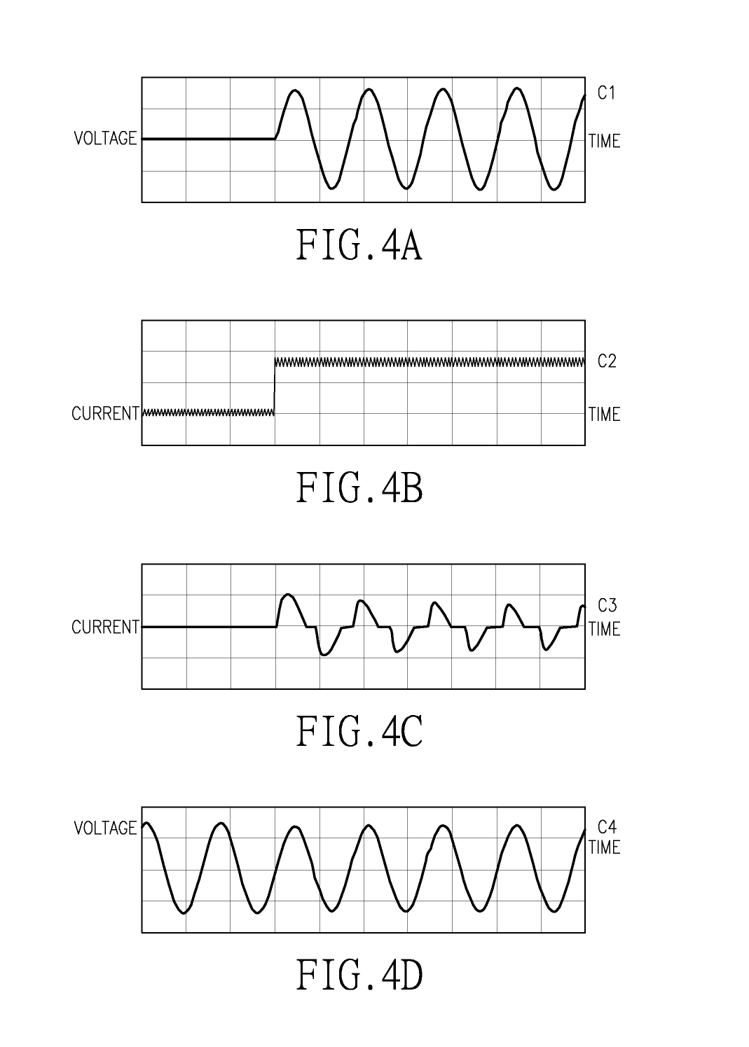

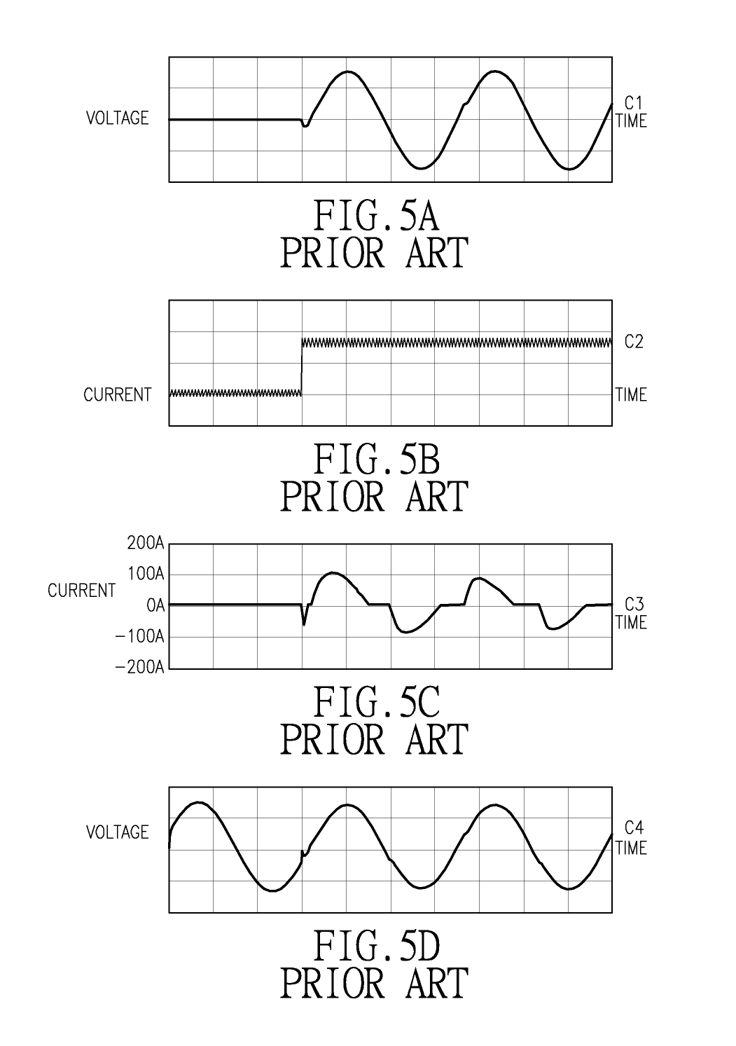

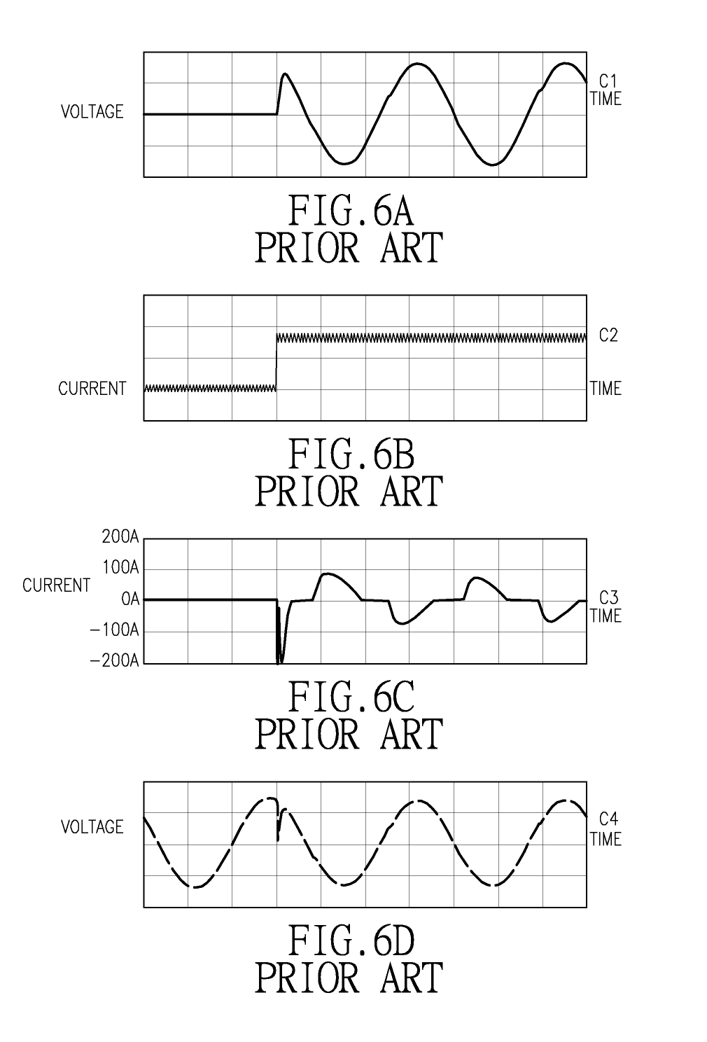

In the aforementioned method, a corresponding controller acquires the switching time of each switching element when the switching element is switched on or off. The controller determines a length of the actual switching time based on the acquired switching status of the switching element. When the switching element needs to be switched again, the controller sends a driving signal to the switching element associated with switching status to locate the switching time of the switching element in the proximity of the zero phase angle point of the input voltage cycle. With reference to FIGS. 4A to 4D, given the switching time around the zero phase angle point of the input voltage cycle, no large instantaneous current is generated. On the other hand, the synchronous communication among all the controllers of the parallelly connected line-interactive UPSs enables to switch on or off the switching elements so that the load can be evenly shared by all line-interactive UPSs.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A method for controlling a parallel line-interactive uninterruptible power supply (UPS) system having multiple line-interactive UPSs parallelly connected, wherein each line-interactive UPS has a switching element, a power output terminal connected to a load through the switching element, and a controller controlling the switching element to switch on or off and acquiring a switching status from the switching element, wherein the method is executed by the controller and comprises steps of:
switching the switching element;
acquiring the switching status from the switching element and recording a switching time of the switching element associated with the switching status;
determining if the switching element is switched again;
if the switching element is switched again, adjusting the switching time of the switching element associated with the switching status to be located within a preset range of an input voltage cycle; and
communicating with the controllers of other line-interactive UPSs to synchronously operate all the switching elements.

2. The method as claimed in claim 1, wherein in the step of adjusting the switching time of the switching element, the switching time of the switching element is adjusted in the proximity of a zero phase angle point of the input voltage cycle.
